(19) United States
(12) Patent Application Publication
(10) Pub. No.: US 2009/0114538 A1
(43) Pub. Date: May 7, 2009

(54) AUTOMATED BIOCHEMICAL ANALYZER

(76) Inventors: Hiroko TAKAYAMA, Otawara-shi (JP); Hiroo Shinohara, Nasushiobara-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/265,835

(22) Filed: Nov. 6, 2008

(30) Foreign Application Priority Data
Nov. 7, 2007 (JP) 2007-290033

(51) Int. Cl. G01N 27/27

(52) U.S. Cl. 204/407

(57) ABSTRACT

An example of the present invention is an automated biochemical analyzer which executes a process of analyzing a sample to be tested. The analyzer includes, an electrolyte detection unit which measures ions in the sample, a constant temperature bath which holds a solution mixture of the sample and the reagent at a predetermined measurement temperature, a cleaning unit which executes a cleaning process of cleaning at least one of parts used in a process of analyzing the sample, an analysis unit which executes an analysis process on at least one liquid of an additive to be added to the constant temperature bath, a cleaning solution to be used in the cleaning process, and an electrolytic solution to be used in the electrolyte detection unit, and acquires an index for representing properties, and a control unit which determines whether the index falls within a preset appropriate range.

### CROSS-REFERENCE TO RELATED APPLICATIONS

This application is based upon and claims the benefit of priority from prior Japanese Patent Application No. 2007-290033, filed Nov. 7, 2007, the entire contents of which are incorporated herein by reference.

### BACKGROUND OF THE INVENTION

1. Field of the Invention

The present invention relates to an automated biochemical analyzer (automatic analyzer) for analyzing the components of a sample to be tested.

2. Description of the Related Art

As an analyzer for analyzing the components of an object to be tested, an apparatus which measures various components in a sample to be tested taken from the object is known. This apparatus comprises, e.g., various probes for isolating and dispensing an object to be tested and reagent, a constant temperature bath for holding a reaction cuvette at a predetermined temperature, a photometric device for measuring the absorbance such as the light transmitting amount of a solution mixture prepared by mixing the sample to be tested and reagent, a mixing device having a mixer for mixing the solution mixture, and an electrolyte measuring device for measuring the ion concentration by an electrode dipped in an electrolytic solution (e.g., Jpn. Pat. Appln. KOKAI Publication No. 2004-219352). To prevent cross-contamination between samples to be tested, reagents, and solution mixtures, the apparatus further comprises a cleaning device for cleaning the various probes, mixer, and reaction cuvette, and cleans them with water or a cleaning solution.

However, the analyzer described above has the following problem. That is, solutions other than previously designated solutions are sometimes used as, e.g., additives to be added to the constant temperature bath, cleaning solutions, and electrolytic solutions. Since it is impossible to detect whether these solutions have desirable quality, the quality, effect, and influence of each solution are difficult to maintain. Accordingly, the effect and influence of the solution sometimes deteriorate the desired apparatus performance, e.g., sometimes causes a failure of a part in contact with the solution.

### BRIEF SUMMARY OF THE INVENTION

It is, therefore, an object of the present invention to provide an analyzer capable of maintaining the quality, effect, and influence of a solution.

An example of the present invention is an automated biochemical analyzer which executes a process of analyzing a sample to be tested, the analyzer comprising, a sample dispensing unit which dispenses the sample to be tested from a sample vessel into a reaction cuvette, a reagent dispensing unit which dispenses the reagent from a reagent vessel into the reaction cuvette, an electrolyte detection unit which measures ions in the sample to be tested, a constant temperature bath which holds a solution mixture of the sample to be tested and the reagent in the reaction cuvette at a predetermined measurement temperature, a cleaning unit which executes a cleaning process of cleaning at least one of parts used in a process of analyzing the sample to be tested, an analysis unit which executes an analysis process on at least one liquid of an additive to be added to the constant temperature bath, a cleaning solution to be used in the cleaning process, and an electrolytic solution to be used in the electrolyte detection unit, and acquires an index for representing properties of the at least one liquid, and a control unit which determines whether the index falls within a preset appropriate range.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a view exemplarily showing the arrangement of an automatic analyzer according to the first embodiment of the present invention;

FIG. 2 is a flowchart showing the steps of a solution analysis process in the automatic analyzer shown in FIG. 1;

FIG. 3 is a graph showing an example of the result of measurement in the solution analysis process shown in FIG. 2;

FIG. 4 is a flowchart showing the steps of a solution analysis process according to the second embodiment of the present invention;

FIG. 5 is a flowchart showing the steps of a solution analysis process according to the third embodiment of the present invention;

FIG. 6 is a view exemplarily showing the arrangement of an automatic analyzer according to the fourth embodiment of the present invention;

FIG. 7 is a flowchart showing the steps of a solution analysis process in the automatic analyzer shown in FIG. 6;

FIG. 8 is a view exemplarily showing the arrangement of an automatic analyzer according to the fifth embodiment of the present invention;

FIG. 9 is a flowchart showing the steps of a solution analysis process performed by the automatic analyzer shown in FIG. 8;

FIG. 10 is a view exemplarily showing the arrangement of an automatic analyzer according to the sixth embodiment of the present invention;

FIG. 11 is a perspective view showing an outline of the arrangement of a cleaning solution reservoir according to the sixth embodiment;

FIG. 12 is a perspective view showing a cleaning container according to the seventh embodiment of the present invention;

FIG. 13 is a perspective view showing an installation unit according to the seventh embodiment; and

FIG. 14 is a flowchart showing the steps of a solution analysis process according to the eighth embodiment of the present invention.

### DETAILED DESCRIPTION OF THE INVENTION

### First Embodiment

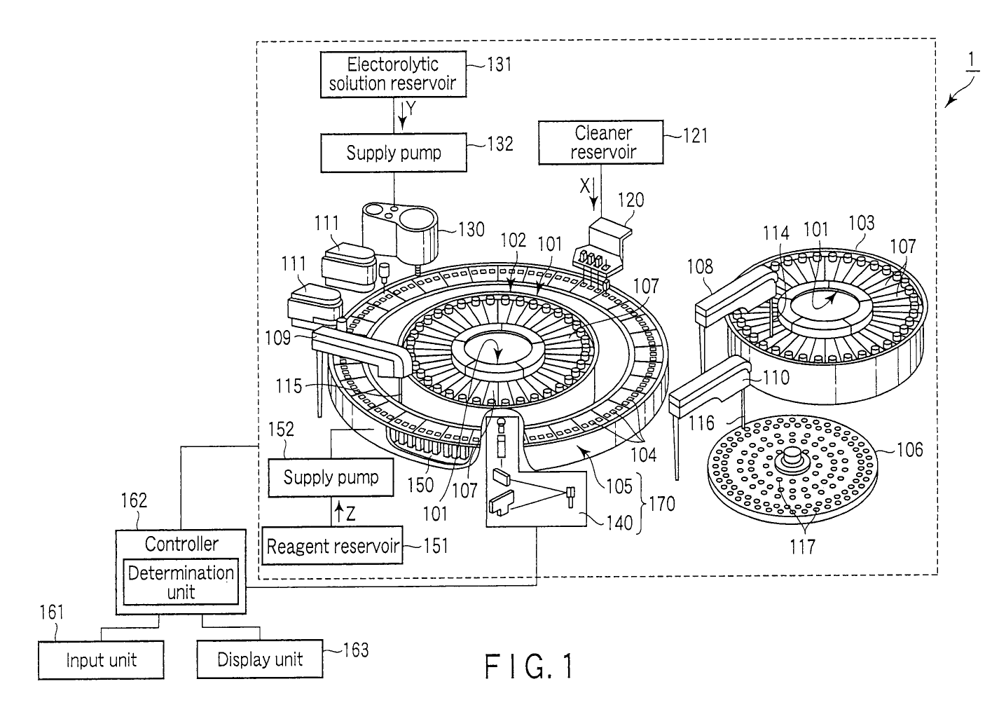

Embodiments of the present invention will be explained below with reference to the accompanying drawing. FIG. 1 is a perspective view exemplarily showing the arrangement of an automatic analyzer 1 (analyzer) according to the first embodiment of the present invention. The automatic analyzer 1 comprises a first reagent reservoir 102, a second reagent reservoir 103, a reaction disk 105 as a reaction mechanism, a sample disk 106 as a sample rack, an automatic cleaning device 120 (cleaning device), an electrolyte measuring device 130 as an electrolyte detector, a constant temperature bath 150, a reagent reservoir 151 different from the first reagent reservoir 102 or the second reagent reservoir 103, a supply pump 152, a photometric device 140, an input unit 161, a controller 162, a display unit 163, and a solution analyzer 170 as a solution analysis means.

A plurality of reagent racks 101 capable of accommodating a plurality of reagent vessels 107 each containing a reagent are installed in the first reagent reservoir 102.

The reaction disk 105 installed around the first reagent reservoir 102 has a ring-like shape and is rotated by a rotating mechanism. In the reaction disk 105, a plurality of holders capable of holding a plurality of reaction cuvettes are arranged in the form of a ring.

The second reagent reservoir 103 formed adjacent to the reaction disk 105 can accommodate a plurality of reagent vessels 107 similarly to the first reagent reservoir 102.

The sample disk 106 can hold a plurality of sample vessels 117 each containing a sample to be tested.

The automatic analyzer 1 further comprises a first reagent arm 108, second reagent arm 109, and sample arm 110. The first reagent arm 108 has a first reagent probe 114 as a reagent dispensing mechanism that sucks a reagent from the reagent vessel 107 placed in the first reagent reservoir 102, and discharges the reagent into the reaction cuvette 104. The second reagent arm 109 has a second reagent probe 115 as a reagent dispensing mechanism that sucks a reagent from the reagent vessel 107 placed in the second reagent reservoir 103, and discharges the reagent into the reaction cuvette 104. The sample arm 110 has a sample probe 116 as a sample dispensing mechanism that sucks a sample from the sample vessel 117 placed in the sample disk 106, and discharges the sample into the reaction cuvette 104.

A mixing device 111, the automatic cleaning device 120, the electrolyte measuring device 130, and the photometric device 140 are arranged around the reaction disk 105. Below the reaction disk 105, the constant temperature bath 150 is formed along the circular orbit of the reaction disk 105.

The mixing device 111 has a function of mixing a solution dispensed in the reaction cuvette 104 by using a mixer 111a.

The automatic cleaning device 120 comprises, e.g., a cleaning solution reservoir 121 as a solution reservoir, a waste solution nozzle 122, a cleaning nozzle 123, and a drying nozzle 124 for drying the interior of the reaction cuvette 104. The cleaning solution reservoir 121 is formed in the lower portion inside the automatic analyzer 1, and contains a plurality of types of cleaning solutions (cleaners, detergents) X.

The waste solution nozzle 122 has a function of sucking a solution from the reaction cuvette 104 after measurement as a waste solution. The cleaning nozzle 123 has a function of discharging the various cleaning solutions in the cleaning solution reservoir 121 and pure water into the reaction cuvette 104. The drying nozzle 124 has a function of drying the interior of the cleaned reaction cuvette 104.

The electrolyte measuring device 130 has a function of supplying a solution to be tested to a channel formed through a housing member, and measuring the ion concentration by an electrode dipped in an electrolytic solution Y. The electrolytic solution Y is stored in an electrolytic solution reservoir 131 as a solution reservoir installed near the cleaning solution reservoir 121 in the lower portion of the automatic analyzer 1, and appropriately supplied by a supply pump 132.

The photometric device 140 has a function of illuminating a liquid portion in the rotating reaction cuvette 104 with light from a light source, measuring the change in absorbance of the solution mixture, and outputting a sample analytical signal obtained by the measurement to the controller 162.

The constant temperature bath 150 forms a circular channel having an open upper end along the circular orbit of the rotating reaction cuvette 104. This channel contains reaction cuvettes 104 and constant temperature water for holding the reaction cuvette 104 at a predetermined temperature. A reagent reservoir 151 as a solution reservoir for storing the constant temperature bath additive Z is installed outside the constant temperature bath 150. The constant temperature bath additive Z is supplied from the reagent reservoir 151 to the constant temperature bath 150 via a supply pump 152. Or, after constant temperature water is supplied, a predetermined amount of the constant temperature bath additive Z in the first reagent reservoir 102 and the reagent containers 107 of the second reagent reservoir 103 is added to the constant temperature bath 150 by reagent probes 114 and 115. It should be noted that the constant temperature bath additive Z is a solution supplied to the constant temperature path in order to prevent microorganisms from being generated in the path.

The input unit 161 has a function of allowing a user to input various commands such as analytical conditions and various command signals required for an analysis process, and transmitting signals corresponding to the inputs to the controller 162.

The controller 162 processes various data obtained by the electrolyte measuring device 130 and photometric device 140, and has a control circuit for controlling the operations of the mechanical portions such as the rotating mechanism, photometric device 140, automatic cleaning device 120, mixing device 111, various arms 108 to 110, various probes 114 to 116, and supply pumps 132 and 152 in order to execute a series of predetermined procedures.

The display unit 163 has a function of displaying measurement results and messages under the control of the controller 162.

In the automatic analyzer 1 having the arrangement as described above, the probes 114 to 116 first dispense a sample to be tested and reagent into the reaction cuvette 104, and the mixer 111a mixes the sample and reagent. The obtained solution mixture is held at a desired measurement temperature in the constant temperature bath 150. The photometric device 140 measures the absorbance of the solution mixture at the desired temperature, and the electrolyte measuring device 130 measures the electrolyte of the solution mixture.

To prevent cross-contamination between samples, reagents, and solution mixtures, the automatic cleaning device 120 cleans the various probes 114 to 116, reaction cuvettes 104, and mixer 111a to be repetitively used. For example, whenever dispensation or mixing is performed, whenever the measurement of a solution mixture is completed, or when the test is completed, automatic cleaning is performed by sucking and discharging water and the cleaning solution, and drying the above-mentioned parts.

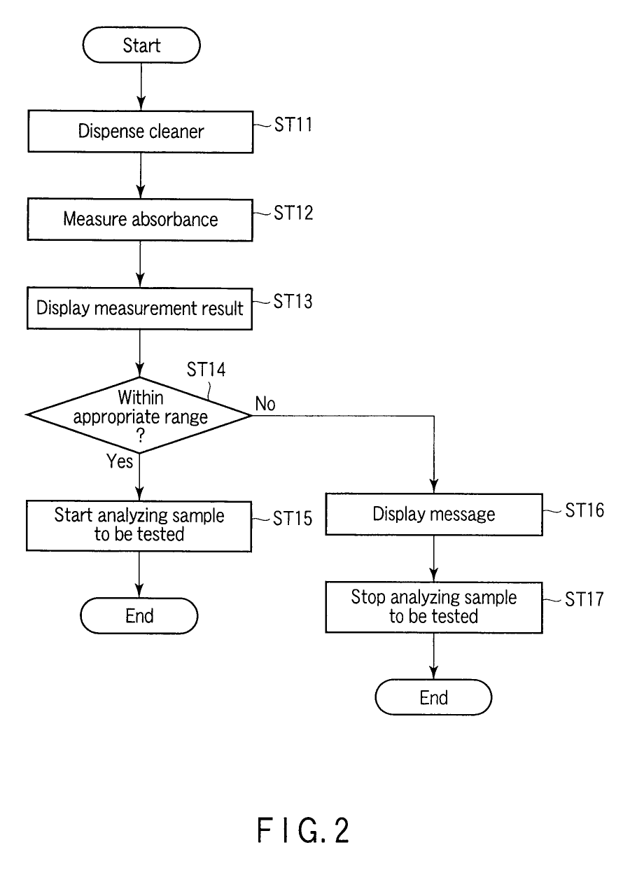

A solution analysis procedure in the automatic analyzer 1 will be explained below with reference to a flowchart shown in FIG. 2.

Note that to make the following explanation practical, solution analysis using the absorbance as an index for representing the properties of liquid (liquid properties) of a cleaning solution will be taken as an example.

Examples of solutions used in the automatic analyzer 1 are a cleaning solution X to be used in automatic cleaning by the automatic cleaning device 120, the constant temperature bath additive Z to be added to the constant temperature bath 150, and the electrolytic solution Y to be used in the electrolyte measuring device 130. In this embodiment, component analysis of the cleaning solution X to be used in the automatic cleaning device 120 will be explained.

The solution analyzer 170 of this embodiment comprises, e.g., the reaction disk 105, the various probes 114 to 116, the photometric device 140, and the controller 162 having a determination unit. The solution analysis process in the solution analyzer 170 is automatically performed, e.g., when the automatic analyzer is activated, or before a sample to be tested is tested.

First, in step ST11, the cleaning solution X is dispensed in the reaction cuvette 104. The cleaning solution X is partially stored in the cleaning solution reservoir 121, and partially in the reagent reservoirs 102 and 103. When using the portion of cleaning solution X stored in the cleaning solution reservoir 121, it is dispensed in the reaction cuvette 140 by the automatic cleaning device 120. When using the portion of the cleaner (constant temperature bath additives and the like) stored in the reagent reservoirs 102 and 103, it is dispensed in the reaction cuvette 104 by the reagent probes 114 and 115.

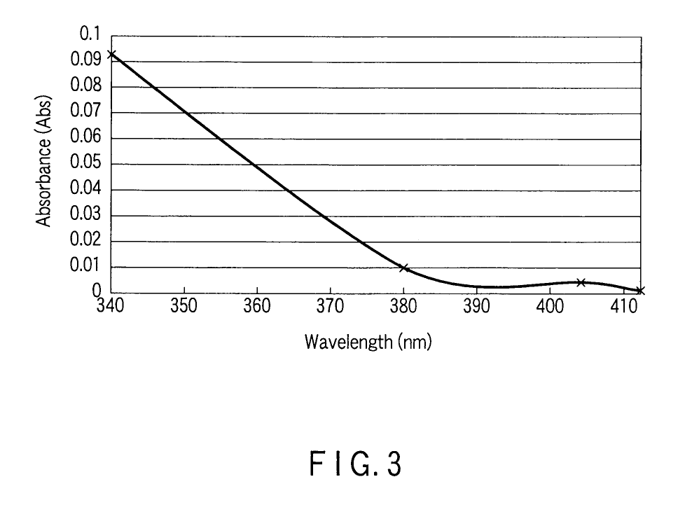

In step ST12, photometry is performed by measuring the absorbance of the cleaning solution X at, e.g., 16 wavelengths. In step ST13, the display unit 163 displays the absorbance measurement result as an absorbance pattern graph as shown in, e.g., FIG. 3.

In step ST14, the absorbance measured in step ST12 is compared with a preset reference absorbance, and whether the measured absorbance falls within a preset appropriate value range is checked.

If it is determined in step ST14 that the measured absorbance falls within the appropriate value range, the quality of the cleaning solution X is regarded as appropriate, and the automatic analyzer 1 starts a sample analysis process (step ST15). Also, in step ST15, information indicating that the absorbance of the cleaning solution falls within the appropriate range and the analysis of a sample to be tested is executed is recorded as a log.

On the other hand, if the measured absorbance falls outside the appropriate value range, the controller 162 controls the display unit 163 to display a message indicating that the liquid properties of the cleaning solution X currently being set fall outside the appropriate value range, or a warning message such as “Use designated cleaning solution” (step ST16), and stops the sample analysis process (step ST17). Also, in step ST17, information indicating that the absorbance of the cleaning solution X falls outside the appropriate range and the analysis of the sample to be tested is stopped is recorded as a log.

The automatic analyzer 1 according to this embodiment achieves the following effects. That is, since the components of the cleaning solution X can be analyzed, it is possible to facilitate maintaining the quality of a cleaning solution to be used, and obtain the desired effect and influence. Accordingly, the desired apparatus performance can be secured. Also, since the photometric device 140 for analyzing a sample to be tested, the reagent probes 114 and 115, the sample probe 116, the automatic cleaning device 120, and the like are used, the automatic analyzer can be implemented without adding any new facilities. In addition, the process of analyzing the cleaning solution X also functions as a process of checking the operation of the sample analysis process in the automatic analyzer 1.

Furthermore, even when a genuine cleaning solution is used, if the quality changes because the useful life has expired, the above-mentioned analyzer can detect that the cleaning solution falls outside the appropriate range.

### Second Embodiment

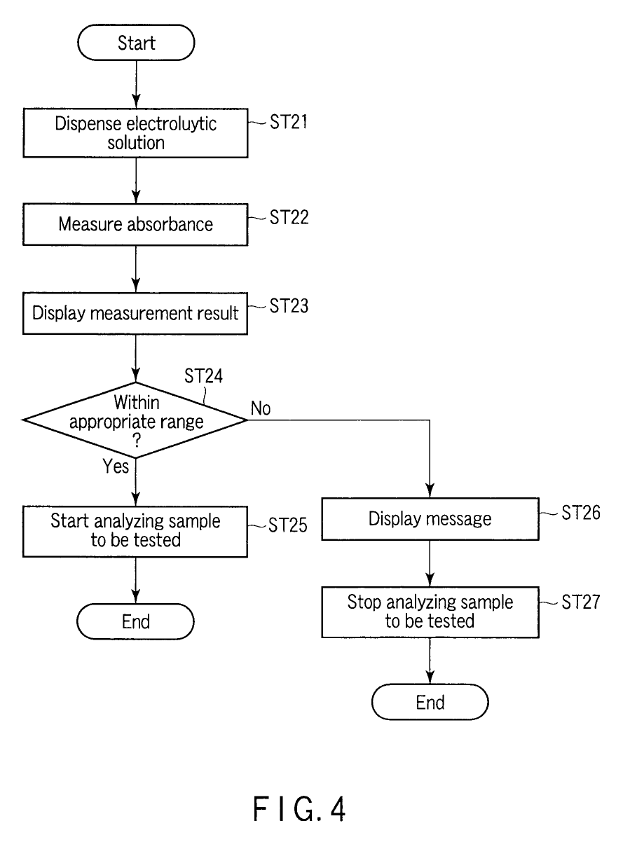

A solution analysis process according to the second embodiment of the present invention will be explained below with reference to FIG. 4. The arrangement of an automatic analyzer of this embodiment is the same as that of the automatic analyzer 1 of the first embodiment, so a repetitive explanation will be omitted. Examples of solutions are a cleaning solution X to be used in an automatic cleaning device 120, an electrolytic solution Y to be used in an electrolyte measuring device 130, and a constant temperature bath additive Z (additive) to be added to a constant temperature bath 150. In this embodiment, component analysis of the constant temperature bath additive Z will be explained.

A solution analyzer 170 of this embodiment comprises, e.g., a reaction disk 105, various probes 114 to 116, a photometric device 140, and a controller 162. The solution analysis process in the solution analyzer 170 is automatically performed, e.g., when the automatic analyzer is activated, or before a sample to be tested is tested.

First, in step ST21, the reagent probe 114 suck a constant temperature bath additive Z from a reagent reservoir 102 and dispense the additive into a reaction cuvette 104. While a reaction disk 105 is rotated, the reaction cuvette 104 containing the constant temperature bath additive Z is fed to the photometric device 140. In step ST22, photometry is performed by measuring the absorbance of the constant temperature bath additive Z at, e.g., 16 wavelengths. In step ST23, a display unit 163 displays the absorbance measurement result as an absorbance pattern graph.

In step ST24, the absorbance measured in step ST22 is compared with a preset reference absorbance, and whether the measured absorbance falls within a preset appropriate value range is checked.

If it is determined in step ST24 that the measured absorbance falls within the appropriate value range, the quality of the constant temperature bath additive Z is regarded as appropriate, and the automatic analyzer 1 starts a sample analysis process (step ST25). Also, in step ST25, information indicating that the absorbance of the constant temperature bath additive Z falls within the appropriate range and the analysis of a sample to be tested is executed is recorded as a log.

On the other hand, if the measured absorbance falls outside the appropriate value range, the controller 162 controls the display unit 163 to display a warning message such as “Use designated constant temperature bath additive” (step ST26), and stops the sample analysis process (step ST27). Also, in step ST27, information indicating that the absorbance of the constant temperature bath additive Z falls outside the appropriate range and the analysis of the sample to be tested is stopped is recorded as a log.

This embodiment can achieve the same effects as those of the first embodiment. That is, since the components of the constant temperature bath additive Z can be analyzed, it is possible to facilitate maintaining the quality of a constant temperature bath additive to be used, and obtain the desired effect and influence.

### Third Embodiment

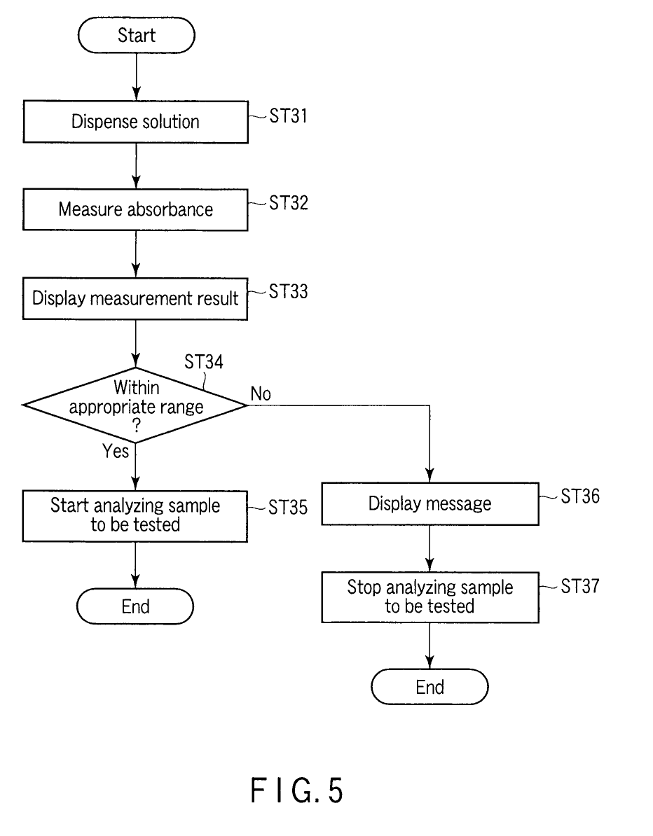

A solution analysis process according to the third embodiment of the present invention will be explained below with reference to FIG. 5. The arrangement of an automatic analyzer used in this embodiment is the same as that of the automatic analyzer 1 of the first embodiment, so a repetitive explanation will be omitted. Examples of solutions are a cleaning solution X to be used in an automatic cleaning device 120, an electrolytic solution Y such as a buffer solution or calibrating solution to be used in an electrolyte measuring device 130, and a constant temperature bath additive Z to be added to a constant temperature bath 150. In this embodiment, component analysis of the electrolytic solution Y will be explained.

A solution analyzer 170 of this embodiment comprises, e.g., a reaction disk 105, various probes 114 to 116, and a photometric device 140. The solution analysis process is automatically performed, e.g., when the automatic analyzer is activated, or before a sample to be tested is tested.

The electrolytic solution Y is a calibrating solution stored in an electrolytic solution reservoir 131 or a buffer solution stored in reagent reservoirs 102 and 103. The electrolytic solution Y stored in the reagent reservoirs 102 and 103 is dispensed in a reaction cuvette 104 by reagent probes 114 and 115. The calibrating solution stored in the electrolytic solution reservoir 131 is supplied to a pot provided under an electrode unit of the electrolyte measuring device, and thus the solution is suctioned by the electrode unit. Alternatively, the calbrating solution may be contained in the reagent containers 107 of the reagent reservoirs 102 and 103, and dispensed to the reaction cuvette 104 by the reagent probes 114 and 115. A reaction cuvette 104 containing the electrolytic solution Y is fed to the photometric device 140. In step ST32, photometry is performed by measuring the absorbance of the electrolytic solution Y at, e.g., 16 wavelengths. In step ST33, a display unit 163 displays the absorbance measurement result as an absorbance pattern graph.

In step ST34, the absorbance measured in step ST32 is compared with a preset reference absorbance, and whether the measured absorbance falls within a preset appropriate value range is checked.

If it is determined in step ST34 that the measured absorbance falls within the appropriate value range, the quality of the electrolytic solution Y is regarded as appropriate, and the automatic analyzer 1 starts a sample analysis process (step ST35). Also, in step ST35, information indicating that the absorbance of the electrolytic solution Y falls within the appropriate range and the analysis of a sample to be tested is executed is recorded as a log.

On the other hand, if the measured absorbance falls outside the appropriate value range, the display unit 163 displays a warning message such as “Use designated electrolytic solution” (step ST36), and the sample analysis process is stopped (step ST37). Also, in step ST37, information indicating that the electrolytic solution Y falls outside the appropriate range and the analysis of the sample to be tested is stopped is recorded as a log.

This embodiment can achieve the same effects as those of the first or second embodiment. That is, since the components of the electrolytic solution Y can be analyzed, it is possible to facilitate maintaining the quality of an electrolytic solution to be used, and obtain the desired effect and influence.

### Fourth Embodiment

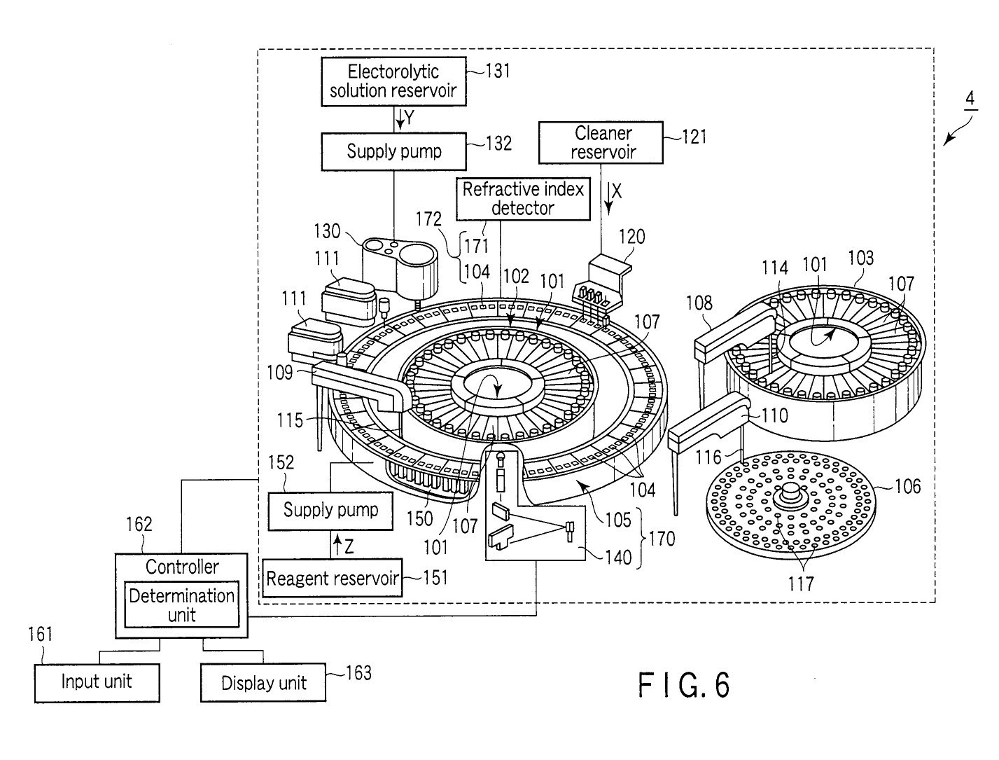

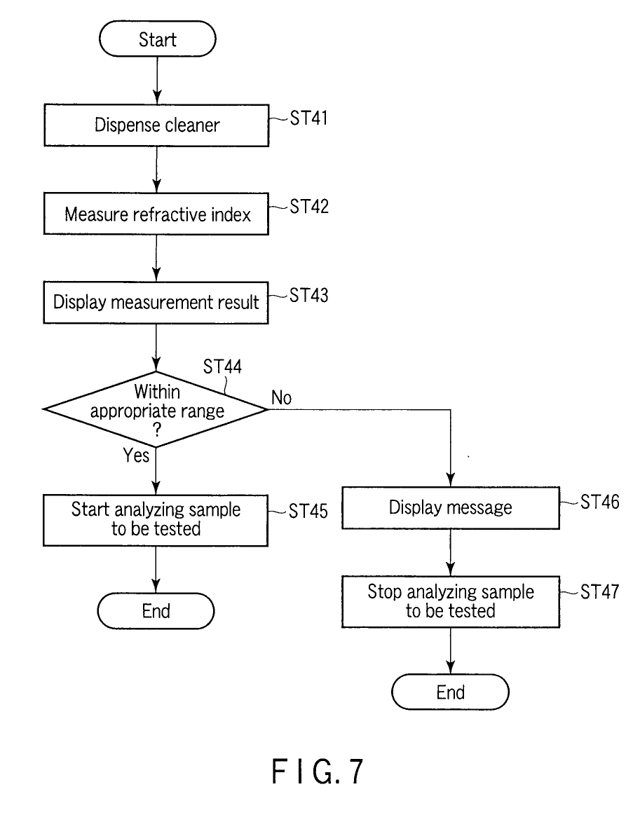

An automatic analyzer 4 and a solution analysis process according to the fourth embodiment of the present invention will be explained below with reference to FIGS. 6 and 7. The arrangement of the automatic analyzer 4 except for a refractive index detector 171 is the same as that of the automatic analyzer 1 of the first embodiment, so a repetitive explanation will be omitted. In this embodiment, component analysis of a cleaning solution X as a solution will be explained.

The automatic analyzer 4 according to this embodiment comprises the refractive index detector 171 for detecting information concerning the refractive index of a solution, and sending the information to a controller 162.

A solution analyzer 172 of this embodiment comprises, e.g., a reaction disk 105, various probes 114 to 116, and the refractive index detector 171. The solution analysis process is automatically performed, e.g., when the automatic analyzer 4 is activated, or before a sample to be tested is tested.

First, in step ST41, the cleaning solution X is sucked from a cleaning solution reservoir 121 or the reagent reservoirs 102, 103 and supplied to the refractive index detector 171. In step ST42, the refractive index of the cleaning solution X is measured. In step ST33, a display unit 163 displays the refractive index measurement result as a graph.

In step ST44, the refractive index measured in step ST42 is compared with a preset reference refractive index, and whether the measured refractive index falls within a preset appropriate value range is checked. For example, when the reference refractive index is 14.5% and the appropriate range is 0.5%, it is determined that the measured refractive index falls within the appropriate value range if the refractive index is 14.0%, to 15.0%, and that the measured refractive index falls outside the appropriate value range if the refractive index is smaller than 14.09% or larger than 15.0%.

If it is determined in step ST44 that the measured refractive index falls within the appropriate value range, the quality of the cleaning solution X is regarded as appropriate, and the automatic analyzer 4 starts a sample analysis process (step ST45). Also, in step ST45, information indicating that the refractive index of the cleaning solution X falls within the appropriate range and the analysis of a sample to be tested is executed is recorded as a log.

On the other hand, if the measured refractive index falls outside the appropriate value range, the display unit 163 displays a warning message such as “Use designated cleaning solution” (step ST46), and the sample analysis process is stopped (step ST47). Also, in step ST47, information indicating that the refractive index of the cleaning solution X falls outside the appropriate range and the analysis of the sample to be tested is stopped is recorded as a log.

This embodiment can achieve the same effects as those of the first embodiment or the like. That is, since the components of the cleaning solution X can be analyzed, it is possible to facilitate maintaining the quality of a cleaning solution to be used, and obtain the desired effect and influence.

### Fifth Embodiment

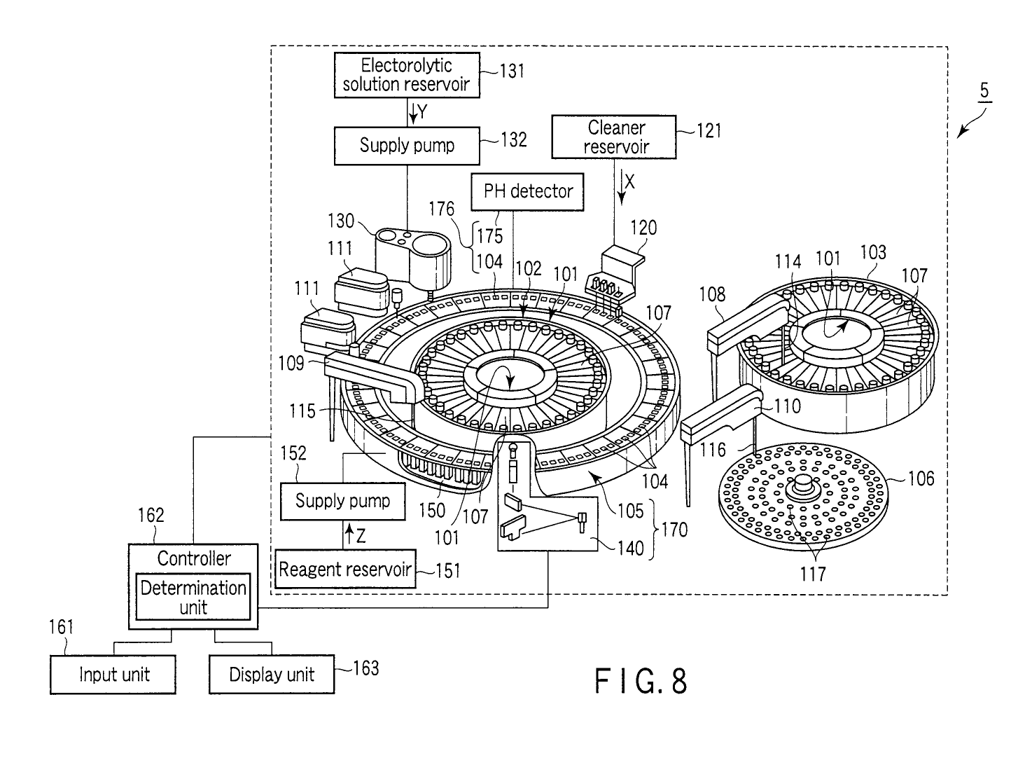

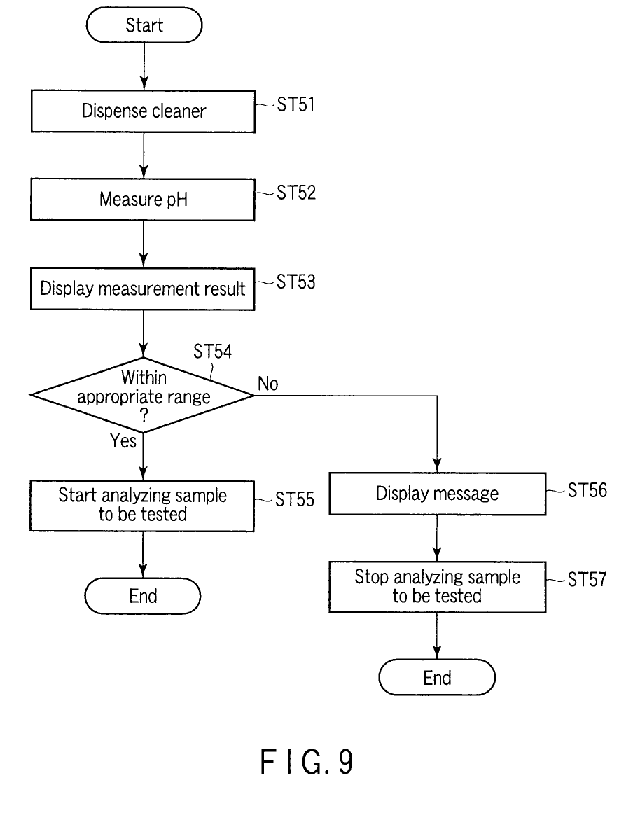

An automatic analyzer 5 and a solution analysis process according to the fifth embodiment of the present invention will be explained below with reference to FIGS. 8 and 9. The arrangement of the automatic analyzer 5 except for a pH detector 175 is the same as that of the automatic analyzer 1 of the first embodiment, so a repetitive explanation will be omitted. In this embodiment, component analysis of a cleaning solution X as a solution will be explained.

The automatic analyzer 5 according to this embodiment comprises the pH detector 175 for detecting information concerning the hydrogen ion exponent of a solution, and sending the information to a controller 162. A solution analyzer 176 of this embodiment comprises, e.g., a reaction disk 105, various probes 114 to 116, and the pH detector 175. The solution analysis process is automatically performed, e.g., when the automatic analyzer 5 is activated, or before a sample to be tested is tested.

First, in step ST51, the cleaning solution X is sucked from a cleaning solution reservoir 121 or the reagent reservoirs 102, 103 and supplied to the pH detector 175. In step ST52, the hydrogen ion exponent of the cleaning solution is measured. In step ST53, a display unit 163 displays the hydrogen ion exponent measurement result as a graph.

In step ST54, the hydrogen ion exponent measured in step ST52 is compared with a preset reference hydrogen ion exponent, and whether the measured hydrogen ion exponent falls within a preset appropriate value range is checked.

If it is determined in step ST54 that the measured hydrogen ion exponent falls within the appropriate value range, the quality of the cleaning solution is regarded as appropriate, and the automatic analyzer 5 starts a sample analysis process (step ST55). Also, in step ST55, information indicating that the hydrogen ion exponent of the cleaning solution X falls within the appropriate range and the analysis of a sample to be tested is executed is recorded as a log.

On the other hand, if the measured hydrogen ion exponent falls outside the appropriate value range, the display unit 163 displays a warning message such as “Use designated cleaning solution” (step ST56), and the sample analysis process is stopped (step ST57). Also, in step ST57, information indicating that the hydrogen ion exponent of the cleaning solution falls outside the appropriate range and the analysis of the sample to be tested is stopped is recorded as a log.

This embodiment can achieve the same effects as those of the first embodiment or the like. That is, since the components of the cleaning solution X can be analyzed, it is possible to facilitate maintaining the quality of a cleaning solution to be used, and obtain the desired effect and influence.

### Sixth Embodiment

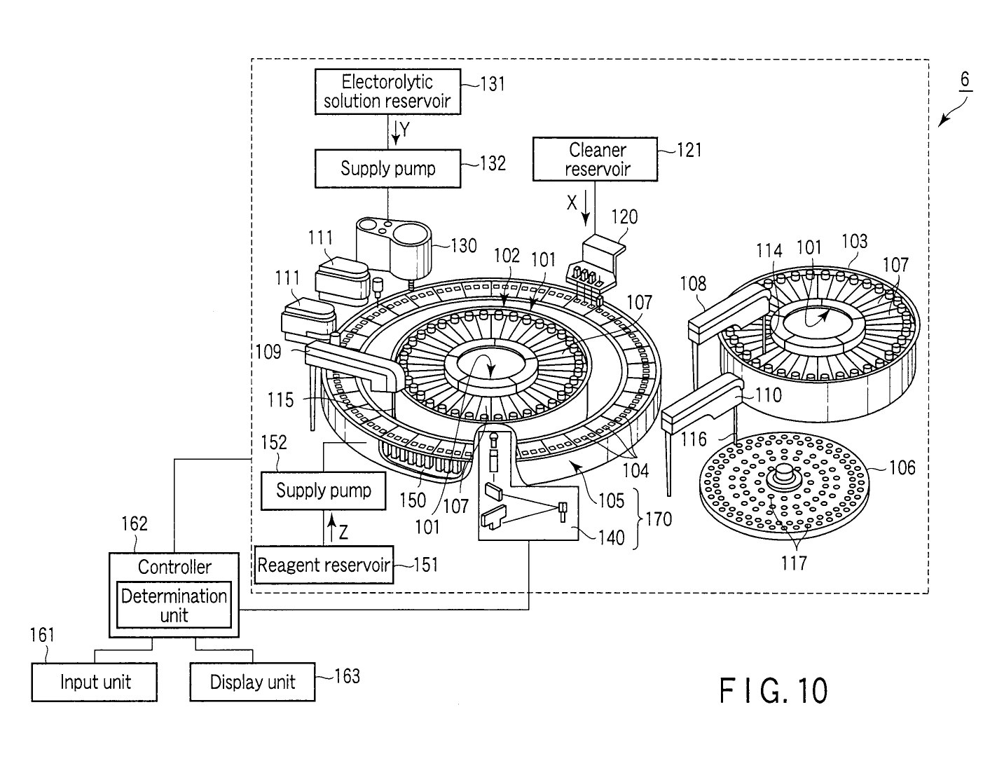

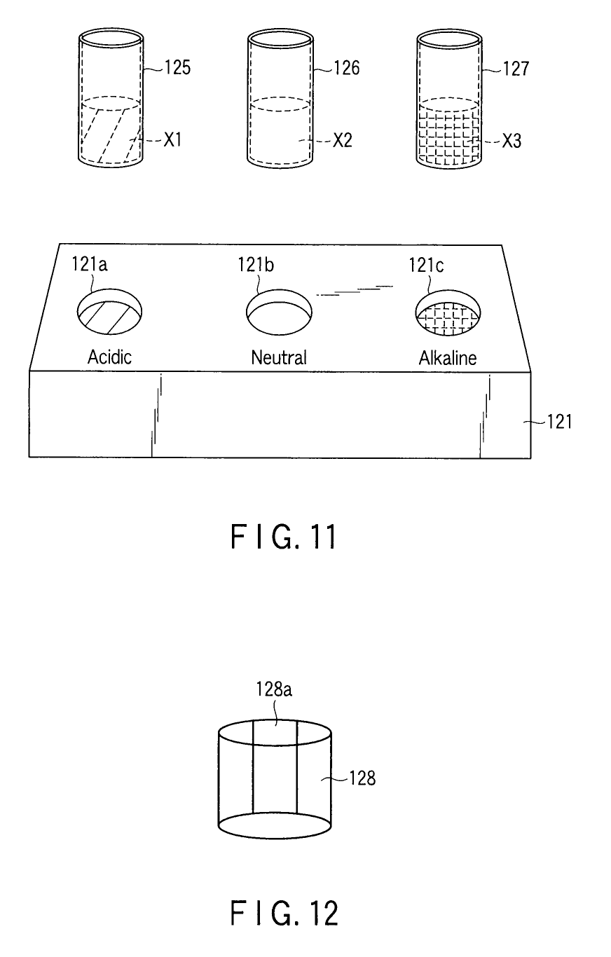

An automatic analyzer 6 according to the sixth embodiment of the present invention will be explained below with reference to FIGS. 10 and 11. The automatic analyzer 6 of this embodiment is the same as the automatic analyzer 1 except that cleaning solution vessels 125 to 127 and a cleaning solution reservoir 121 forming a solution discriminating mechanism have different colors, so a repetitive explanation will be omitted.

The cleaning solution reservoir 121 according to this embodiment includes the plurality of cleaning solution vessels 125, 126, and 127 as solution containers. The plurality of cleaning solution vessels 125, 126, and 127 respectively contain an acidic cleaning solution X1, neutral cleaning solution X2, and alkaline cleaning solution X3. The plurality of cleaning solutions set in the cleaning solution reservoir 121 are colored in accordance with their components by, e.g., adding additives that change their colors in accordance with the components. For example, the acidic cleaning solution X1 is colored red, and the alkaline cleaning solution X3 is colored blue. This makes it possible to discriminate between the cleaning solutions by their colors.

The cleaning solution vessels 125 to 127 are colored in accordance with the colors of the cleaning solutions contained in these vessels. In addition, installation portions 121a to 121c of the cleaning solution reservoir in which the plurality of cleaning solution vessels 125 to 127 are installed are colored in accordance with the designated cleaning solution colors. For example, the acidic cleaning solution X1, the cleaning solution vessel 125 containing the acidic cleaning solution X1, and the installation portion 121a in which the cleaning solution vessel 125 is installed are colored red. The neutral cleaning solution X2, the cleaning solution vessel 126 containing the neutral cleaning solution X2, and the installation portion 121b in which the cleaning solution vessel 126 is installed are colorless or colored white. The alkaline cleaning solution X3, the cleaning solution vessel 127 containing the alkaline cleaning solution X3, and the installation portion 121c in which the cleaning solution vessel 127 is installed is colored blue.

This embodiment can achieve the same effects as those of the above embodiments. That is, it is possible to allow the user to set a plurality of types of cleaning solutions in correct positions by using different colors. This facilitates maintaining the quality of a solution by preventing each cleaning solution from being set in a wrong position. Also, since the cleaning solutions and the like are discriminated from each other by colors, the discrimination is easy even when using an image processor to check the installation. Accordingly, a simple (inexpensive) image processor is applicable.

### Seventh Embodiment

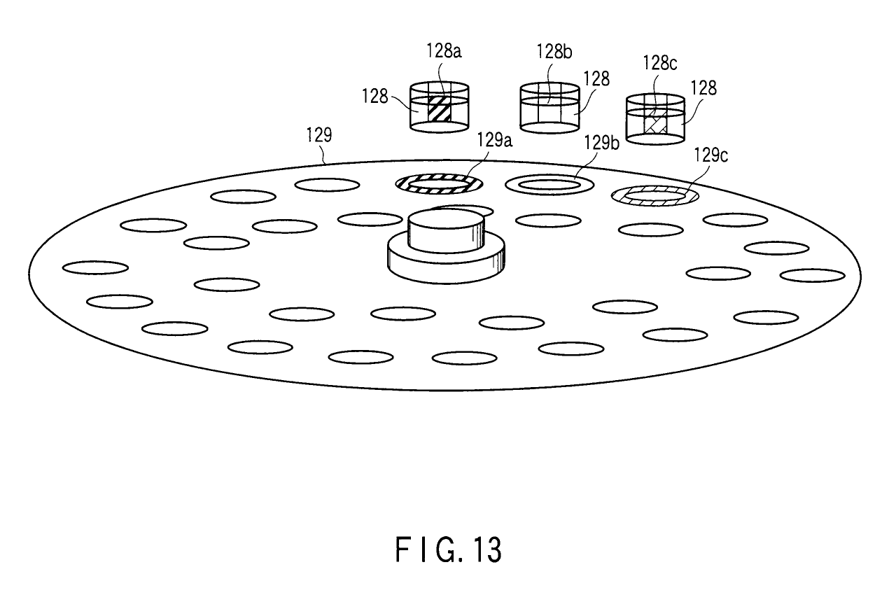

An automatic analyzer 7 and solution containers according to the seventh embodiment of the present invention will be explained below with reference to FIGS. 12 and 13. The automatic analyzer 7 of this embodiment is the same as the automatic analyzer 1 except for the change in color of a solution container 128 to be used, so a repetitive explanation will be omitted.

As shown in FIG. 12, the solution containers according to this embodiment have band-like color changing portions 128a to 128c formed by using different materials on the inner wall surfaces of the solution containers. The band-like color changing portions 128a to 128c are each made of a material that changes its color in response to the type, hydrogen ion exponent, or the like of a solution. For example, the material contains a component contained in litmus test paper, and changes its color when a solution is contained. For example, the band-like color changing portion 128a formed in the container of an acidic cleaning solution changes its color to red, the color changing portion 128b for a neutral cleaning solution remains colorless, and the color changing portion 128c for an alkaline cleaning solution changes its color to blue.

FIG. 13 shows an installation unit 129 in which cleaning solutions are installed. Referring to FIG. 13, the installation unit 129 is a sample rack for accommodating samples to be tested. The installation unit 129 has identification marks 129a to 129c having the same colors as those obtained by the changes. For example, the mark 129a for an acidic cleaning solution is red, the mark 129b for a neutral cleaning solution is colorless, and the mark 129c for an alkaline cleaning solution is blue.

A sampling probe 116 can clean its interior by sucking the installed cleaning solution. When removing contamination, an acidic, neutral, or alkaline cleaning solution is normally used in accordance with the components of the contamination. If an inadequate cleaning solution is used, not only the contamination cannot be removed, but also the probe surface may be damaged. Therefore, the installation of cleaning solutions is an important operation. A non-odorous, colorless cleaning solution may be installed in a wrong place because the contents are unknown, so the cleaning solution must be installed with caution. In this embodiment as described above, however, the vessel changes its color in accordance with the type of contained cleaning solution, and this makes it possible to prevent the cleaning solution from being installed in a wrong place. Also, since the difference between the color of the band-like member 128a, 128b, or 128c and that of the mark 129a, 129b, or 129c can be readily perceived, the user can immediately recognize that the cleaning solution is installed in a wrong place. This makes a rapid countermeasure such as replacement of the cleaning solution or cleaning of the solution container possible.

### Eighth Embodiment

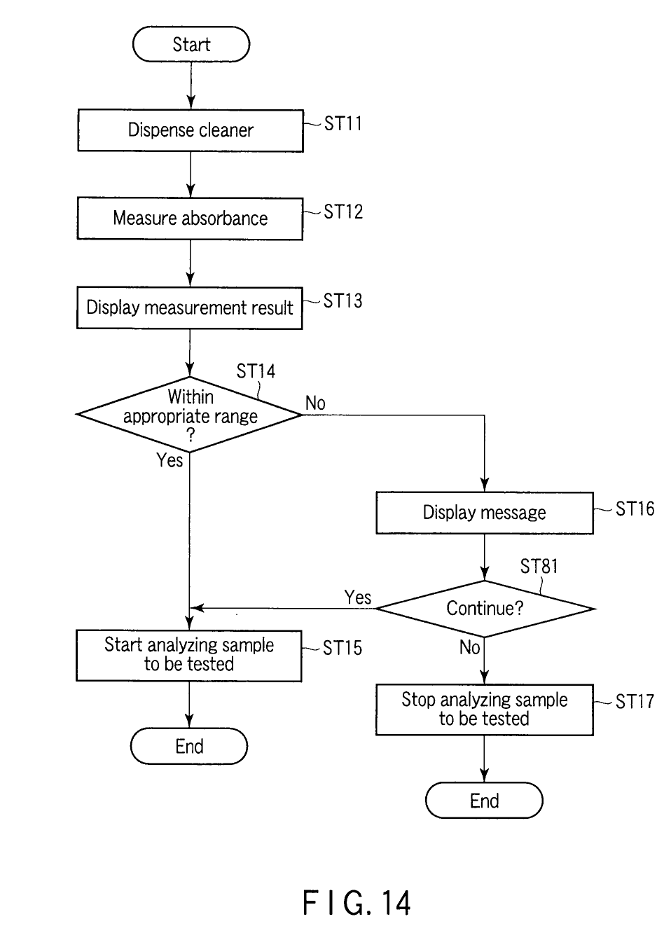

A solution analysis process according to the eighth embodiment of the present invention will be explained below with reference to FIG. 14.

Note that the arrangement of an automatic analyzer of this embodiment is the same as that of the automatic analyzer 1 of the first embodiment, so a repetitive explanation will be omitted.

Note also that the steps of this embodiment are the same as those of the first embodiment except that step (step ST) 81 of determining whether to continue the analysis of a sample to be tested is executed after the message is displayed in step ST16, and the process advances to step ST15 if it is determined in step ST81 that the analysis is to be continued, so a repetitive explanation will be omitted.

In this embodiment, as in the first embodiment, a cleaning solution is dispensed in step ST11, the absorbance is measured in step ST12, the measurement result is displayed in step ST13, and whether the measurement result falls within an appropriate range is checked in step ST14.

If the measurement result falls within the appropriate range (Yes in step ST14), the analysis of a sample to be measured is started in the same manner as in the first embodiment (step ST15). If the measurement result falls outside the appropriate range in step ST14 (No in step ST14), a message indicating that the measurement result falls outside the appropriate range is displayed (step ST16).

Then, whether to continue the analysis of the sample is checked in step ST81. For example, a message such as “Continue analysis of sample?” for urging the user to input an instruction indicating whether to continue the analysis is displayed in step ST16 together with the message indicating that the measurement result falls outside the appropriate range. In response to this message, the user inputs an instruction indicating whether to continue the analysis from an input unit 16.

If the user inputs an instruction indicating the continuation, it is determined in step ST81 that the analysis is to be continued, and the process advances to step ST15 to start analyzing the sample. In this case, information indicating that the measurement result falls outside the appropriate range and the analysis of the sample is continued is recorded as a log.

On the other hand, if the user inputs an instruction indicating that the analysis of the sample is not to be continued, the process advances to step ST17 to stop analyzing the sample. In this case, information indicating that the measurement result falls outside the appropriate range and the analysis of the sample is stopped is recorded as a log. Furthermore, if it is determined in step ST14 that the measurement result falls outside the appropriate range and it is determined in step ST81 that the analysis is to be continued, information indicating that the cleaning solution used falls outside the appropriate range is displayed together with the result of the sample analysis executed in step ST15. For example, a message such as “Cleaning solution falling outside appropriate range was used” is displayed.

This embodiment can achieve the same effects as those of the first embodiment or the like. In addition, even when the measurement result falls outside the appropriate range, the analysis process can be continued if the user determines that it is unnecessary to stop the analysis. Accordingly, the automatic analyzer can be used in accordance with the user's environment.

Note that the present invention is not limited to the above embodiments, and can be practiced by properly changing the constituent elements. For example, a solution is directly analyzed in the first to third embodiments, but it is also possible to add a material (e.g., a dye) having a singular absorption band to a solution, and analyze the solution mixture while the material and solution are reacting with each other.

Also, a solution is tested when the analyzer is activated, but the present invention is not limited to this. For example, the test may also be periodically performed at a preset interval. Furthermore, the automatic analyzers 1, 4, 5, 6, and 7 may also be operated by the operator via the input unit 161, or operated with time. These analyzers may also be automatically operated at a certain predetermined timing, e.g., when the analyzers are shut down, or for every preset number of objects to be measured.

It is also possible to perform analysis by detecting the specific gravity, surface tension, viscosity, or the like, instead of the absorbance, hydrogen ion exponent, or refractive index detected in the above embodiments, as an index for representing the liquid properties. Although a cleaning solution is analyzed in the fourth to eighth embodiments, these embodiments are also applicable to other solutions such as the electrolytic solution Y and constant temperature bath additive Z of the second and third embodiments. Furthermore, it is also possible to combine the plurality of analysis processes described above, and allow a single automatic analyzer to analyze a plurality of types of solutions.

That is, in each of the above embodiments, determination is performed on the basis of one of the absorbance, hydrogen ion exponent, refractive index, specific gravity, surface tension, and viscosity of a solution as an index. However, determination may also be performed by combining two or more of the plurality of indices.

Furthermore, solutions as objects of index analysis and determination are not limited to the cleaning solution, constant temperature bath additive, and electrolytic solution exemplified in the above embodiments.

The present invention can be embodied by modifying the constituent elements without departing from the spirit and scope of the invention when practiced. In addition, various inventions can be formed by properly combining the plurality of constituent elements disclosed in the embodiments. It is possible to delete some of all the constituent elements disclosed in the embodiments, or properly combine constituent elements of different embodiments.

Additional advantages and modifications will readily occur to those skilled in the art. Therefore, the present invention in its broader aspects is not limited to the specific details, representative devices, and illustrated examples shown and described herein. Accordingly, various modifications may be made without departing from the spirit or scope of the general inventive concept as defined by the appended claims and their equivalents.

What is claimed is:

1. An automated biochemical analyzer which executes a process of analyzing a sample to be tested, the analyzer comprising:
a sample dispensing unit which dispenses the sample to be tested from a sample vessel into a reaction cuvette;
a reagent dispensing unit which dispenses the reagent from a reagent vessel into the reaction cuvette;
an electrolyte detection unit which measures ions in the sample to be tested;
a constant temperature bath which holds a solution mixture of the sample to be tested and the reagent in the reaction cuvette at a predetermined measurement temperature;
a cleaning unit which executes a cleaning process of cleaning at least one of parts used in a process of analyzing the sample to be tested;
an analysis unit which executes an analysis process on at least one liquid of an additive to be added to the constant temperature bath, a cleaning solution to be used in the cleaning process, and an electrolytic solution to be used in the electrolyte detection unit, and acquires an index for representing properties of the at least one liquid; and
a control unit which determines whether the index falls within a preset appropriate range.

2. The analyzer according to claim 1, further comprising a display unit which, if the determination unit determines that the index falls outside the appropriate range, displays a message based on the determination.

3. The analyzer according to claim 1, wherein the index is at least one of absorbance, hydrogen ion exponent, refractive index, specific gravity, surface tension, and viscosity.

4. The analyzer according to claim 1, wherein the analysis unit acquires absorbance as the index by measuring the absorbance of at least one liquid in a photometric unit which measures absorbance of a sample to be tested.

5. The analyzer according to claim 1, wherein the control unit controls an operation of the analyzer in accordance with the index, and the analyzer further comprising a display unit which displays an analytical result of the sample to be tested and a message based on the determination.

6. The analyzer according to claim 1, wherein if the index falls outside the appropriate range, the control unit stops the process of analyzing the sample to be tested.

7. The analyzer according to claim 1, wherein the control unit determines whether to continue the analysis of the sample to be tested, if the index falls outside the appropriate range.

8. The analyzer according to claim 1, further comprising a recording unit which records information indicating whether the index falls within the appropriate range.

9. The analyzer according to claim 7, further comprising a display unit which displays information indicating that the index falls outside the appropriate range on an analytical result of the sample to be tested if the index falls outside the appropriate range and the analysis of the sample to be tested is continued.
